(19) United States
(12) Patent Application Publication
(10) Pub. No.: US 2022/0314218 A1
(43) Pub. Date: Oct. 6, 2022

(54) SYSTEM FOR SINGLE-USE IMMUNOCHEMICAL TESTS

(71) Applicant: DIESSE DIAGNOSTICA SENESE S.P.A., Milano (IT)

(72) Inventors: Carlo PAOLI, Milano (IT); Andrea IANNIELLO, Milano (IT)

(21) Appl. No.: 17/620,861

(22) PCT Filed: Jun. 18, 2020
(86) PCT No.: PCT/EP2020/066894

§ 371 Date: Dec. 20, 2021

(30) Foreign Application Priority Data
Jun. 21, 2019 (IT) 102019000009810

(51) Int. Cl. B01L 3/00; B01L 9/06

(52) U.S. Cl. CPC B01L 3/50855; B01L 9/06; B01L 2300/168; B01L 2200/16

(57) ABSTRACT

A system for single-use immunochemical tests, comprising a support equipped, along a main direction, with a plurality of housings, including —at least one first housing for the sample to be analyzed, —at least one second housing for substances to be combined with the sample during the test, —at least one third housing for a well carrying a substance to be combined with the sample during the test, characterized in that the surface of said at least one third housing of said support is opaque to light and said well is made of a material at least partially transparent to light, and in that said at least one third housing is —equipped with a through-hole on the bottom, so that a beam of light can pass through said bottom of the third housing and through said well, in order to conduct a colorimetric absorbance test, or —equipped with a closed bottom in order to conduct a luminescence test in the well, —so that said system uses a single type of well at least partly transparent to light to conduct colorimetric absorbance and luminescence tests.

### TECHNICAL FIELD

The present invention relates to the field of immunochemical tests and, in particular, the subject matter of the invention is an optimized structure of a system for single-use immunochemical tests that allows immunochemical tests of luminescent (for example chemiluminescent or fluorescent) type or colorimetric type to be conducted.

### BACKGROUND ART

Immunochemical tests and tests for detecting infection diseases (such as cytomegalovirus, herpes simplex, rubella, toxoplasma, varicella, diphtheria, poliovirus, tetanus, Chlamydophila pneumoniae, Legionella pneumophila, adenovirus, influenza A and B, Chlamydia trachomatis, Helicobacter pylori and many others), autoimmune diseases, allergies, diseases related to endocrine disorders, etc., have been known for some years now.

In immunochemical tests, in order to identify a particular antibody, the antigen targeted by this antibody is used; this antigen will bind to the antibody, if it is present. Conversely, it is possible to use a particular antibody to detect the unknown antigen.

The presence of the antigen-antibody complex thus formed, made visible with particular procedures, indicates the presence of the antibody, or of the antigen, being tested for.

A particular feature of immunochemical tests is that of utilizing an immunological reaction (antigen-antibody bond) to selectively bind the molecule being tested for, coupled with an enzymatic reaction to produce a colored/luminous signal that can be easily measured by the naked eye or quantitively measured with specific photometers.

Immunochemical tests generally use solid phases, to which substances useful for analytical purposes, for example antigens/antibodies, are bound, depending on the type of test.

One of the means most widely used for preparing solid phases provides for the use of wells of microtitration plates. These are small plastic containers, assembled in plates for 96 determinations.

The determinations conducted with this type of support require firms specialized in biochemistry to prepare these solid phases industrially, in practice utilizing the properties of proteins to bind to the plastic.

The end user conducts the test using a kit that typically contains, in addition to the solid phase, one or more splittable 96-well plates and the reagents to conduct the test (calibrator, tracer, substrate, diluent and wash solution for the solid phase).

These 96-well plates are typically made of polystyrene transparent to light as they have to be “read” by a photometer to determine the absorbance of a dye solution.

Reagents for immunochemical determination, with luminescent development (chemiluminescent, or fluorescent) rather than colorimetric, have been developed for some years now.

For example, a photomultiplier measures the emission of light produced in the well. This effect is determined by changing substrate (luminol instead of tetramethylbenzidine TMB). This determination is defined “chemiluminescence immunoassay (CLIA)” and must be conducted in wells that are opaque to light, i.e., not transparent, to prevent cross contamination between wells and interference from external light.

To make immunochemical methods more flexible and adapt them also to the needs of users who have a small number of samples to analyze, single-use tests have been available on the market for some years now. These are devices specifically designed to be able to conduct a single test. Determination can be either qualitative, or quantitative. One type of single-use test is described, for example, in the document EP1255115, by the same applicant and illustrates a single-use test device for conducting immunochemical tests, provided with a pair of housings for receiving respective wells of a microtitration plate, a first cavity for receiving the sample, and further cavities for receiving each of the reagents required to conduct the test.

These single-use tests have become very widely used over the years and are appreciated for their convenient and efficient use.

With the advent of luminescent tests in parallel with colorimetric tests, the firms that prepare these single-use tests are obliged to keep an inventory of two types of wells with the same antigens/antibody: a first series of wells made of a material transparent to light for conducting colorimetric tests (into which the substance to conduct the colorimetric test will be added), and a second series of wells, containing the same substances as the first series of wells, made of a material opaque to light, for conducting luminescence tests (into which the substance to conduct luminescence test will be added). This need gives rise to a much more costly stock management of the wells.

### SUMMARY

The object of the present invention is to provide a system or a kit structure for single-use immunoenzymatic tests that allows optimization of the stock of wells with the useful substances for conducting the tests.

This and other objects, which will be more apparent hereunder, are achieved with a system for single-use immunochemical tests, comprising a well carrying a substance to be combined with the sample to be analyzed during the test, and a support equipped, along a main direction, with a plurality of housings, including at least one first housing for the sample to be analyzed, at least one second housing for substances to be combined with the sample during the test, at least one third housing for a well carrying the substance to be combined with the sample during the test. The particular feature of the structure lies in the fact that the surface of said at least one third housing of the support is opaque to light and this well is made of a material at least partially transparent to light, and in that the at least one third housing is
equipped with a through-hole on the bottom, so that the light can pass through the bottom of the third housing and through the well, in order to conduct a colorimetric absorbance test, or
equipped with a closed bottom in order to conduct a luminescence test in the well,
so that the system uses a single type of well at least partly transparent to light to conduct colorimetric absorbance and luminescence tests.

In the present relation, the term “luminescence” is meant as chemiluminescence test and fluorescence test.

Advantageously, according to preferred embodiments, the entire surface of the support is opaque to light.

Preferably, at least the surface of said at least one third housing of the support is black.

More preferably, the entire surface of the support is black.

According to another aspect, the invention relates to a kit structure for single-use immunochemical tests, comprising a support equipped, along a main direction, with a plurality of housings, including at least one first housing for the sample to be analyzed, at least one second housing for substances to be combined with the sample during the test, at least one third housing for a well carrying a substance to be combined with the sample during the test. The particular feature of the structure lies in the fact that the surface of said at least one third housing of the support is opaque to light and the well is made of a material at least partially transparent to light, and in that the at least one third housing is
equipped with a through-hole on the bottom, so that the light can pass through the bottom of the third housing and through the well, in order to conduct a colorimetric absorbance test, or
equipped with a closed bottom in order to conduct a luminescence test in the well,
   so that the kit structure uses a single type of well at least partly transparent to light to conduct colorimetric absorbance and luminescence tests.

Advantageously, the kit comprises one said well.

Advantageously, according to preferred embodiments, the whole of the surface of the support is opaque to light.

Preferably, for said kit structure for single-use immunoenzymatic tests, the whole of the surface of said support is opaque to light.

Preferably, for said kit structure for single-use immunoenzymatic tests, all of said support is made completely of a material opaque to light.

Preferably, for said kit structure for single-use immunoenzymatic tests, at least the surface of said at least one third housing of said support is black.

Preferably, for said kit structure for single-use immunoenzymatic tests, the entire surface of said support is black.

Preferably, for said kit structure for single-use immunoenzymatic tests, said support extends prevalently in a main direction and has, at one end, an engagement tab and, subsequent thereto, in succession,
one said first housing, with a closed bottom, adapted to contain the sample to be analyzed,
a group of at least three, preferably four, second housings in succession, equipped with a bottom and adapted to contain substances,
at least said two third housings, preferably two, adapted to contain respective said transparent wells,
said at least one fourth housing, preferably one.

Preferably, for said kit structure for single-use immunoenzymatic tests, said at least one fourth housing has no bottom.

Preferably, for said kit structure for single-use immunoenzymatic tests, said at least one second housing is closed at the top by a film fixed to said support.

According to another aspect, the invention relates to a method for the preparation of a single-use immunochemical test for a sample to be analyzed, which involves providing a well made of a material at least partially transparent to light carrying a substance to be combined with the sample during the test, and

if the immunochemical test is of colorimetric absorbance type, providing
a support equipped, along a main direction, with a plurality of housings, including at least one first housing for the sample to be analyzed, at least one second housing for substances to be combined with the sample during the test, at least one third housing for a well carrying the substance to be combined with the sample during the test, wherein the surface of said at least one third housing of said support is opaque to light and moreover the at least one third housing is equipped with a through-hole on the bottom, so that a beam of light can pass through the bottom of the third housing and through the well, in order to conduct a colorimetric absorbance test,
   if the immunochemical test is of luminescence type, providing
a support equipped, along a main direction, with a plurality of housings, including at least one first housing for the sample to be analyzed, at least one second housing for substances to be combined with the sample during the test, at least one third housing for a well carrying the substance to be combined with the sample during the test, wherein the surface of said at least one third housing of the support is opaque to light and said third housing is also equipped with a closed bottom in order to conduct a luminescence test in the well,
   so that the method uses a single type of well at least partly transparent to light to conduct colorimetric absorbance and luminescence tests.

Advantageously, the method involves inserting the well into the third housing.

Advantageously, according to preferred embodiments, the entire surface of the support is opaque to light.

Preferably, the entire surface of said support is opaque to light.

Preferably, said support made completely of a material opaque to light.

Preferably, at least the surface of said at least one third housing of said support is black.

Preferably, the entire surface of said support is black.

Preferably, the support extends prevalently in a main direction and has, at one end, an engagement tab and, subsequent thereto, in succession,
one said first housing, with a closed bottom, adapted to contain the sample to be analyzed,
a group of at least three, preferably four, second housings in succession, equipped with a bottom and adapted to contain substances,
at least said two third housings, preferably two, adapted to contain respective said transparent wells,
said at least one fourth housing, preferably one.

Preferably, the at least one fourth housing has no bottom. Preferably, for said kit structure for single-use immunoenzymatic tests, said at least one second housing is closed at the top by a film fixed to said support.

In practice, due to one or more of the aspects of the invention, firms that manufacture single-use immunochemical tests can have an inventory with a single series of wells made of a transparent containing the substances for carrying out the required determinations. When the test is of colorimetric type, the transparent well is inserted in the housing with no bottom of an opaque support, so that the test can be conducted without limitations. When the test is of luminescent, for example chemiluminescent, type, the transparent well is inserted in the housing with a closed bottom of an opaque support, so that even if the well is transparent, it is surrounded by an opaque interface and the luminescent effect can be measured without problems of interference.

From the viewpoint of production, the wells are substantially identical in shape and material for the various types of tests, and the supports for the wells can advantageously be identical in shape and material, with the exception of the presence of the bottom in the housings of the wells. In this way, the molds for producing the supports can advantageously be the same, with the exception of accessories inserted in the mold cavities to prevent the formation of the bottoms when necessary.

### BRIEF DESCRIPTION OF THE DRAWINGS

The invention will be better understood by following the description and accompanying drawings, which illustrate a non-limiting example of embodiment of the invention. More in particular, in the drawing:

FIG. 1 represents a schematic side view of a transparent well for the kit structure according to the invention;

FIG. 2 represents a schematic side view of a support for wells, opaque, for the kit structure according to the invention;

FIG. 3 represents a schematic top view of the support for wells of FIG. 2;

FIG. 4 represents a cross-sectional schematic side view of a support for wells, opaque, for the kit structure according to the invention, in which the housings of the wells (shown in an exploded view) are equipped with a closed bottom in order to conduct luminescence, for example chemiluminescence, tests;

FIG. 5 represents a cross-sectional schematic side view of the support for wells, opaque, as in FIG. 2, in which the housings of the wells (shown in an exploded view) have no bottom in order to conduct colorimetric tests,

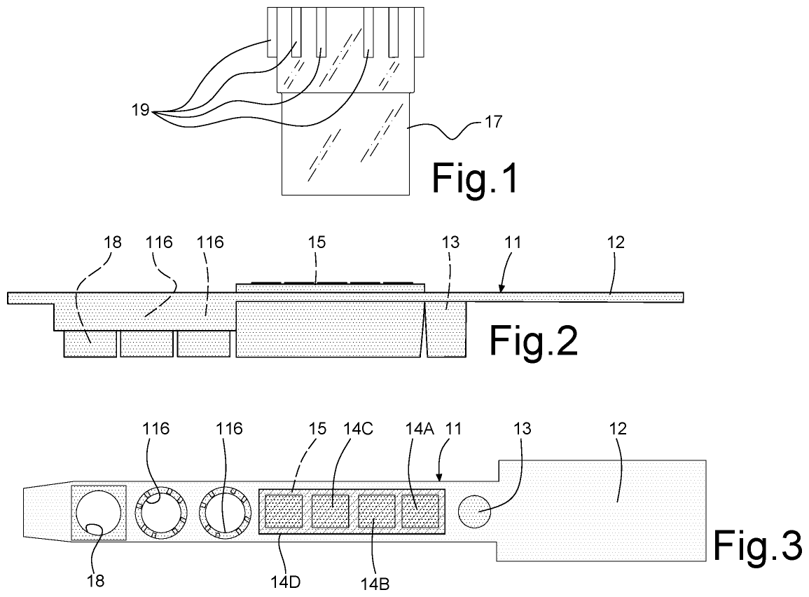

### DETAILED DESCRIPTION OF EMBODIMENTS

With reference to the aforesaid figures, a system, i.e., a kit structure for single-use immunoenzymatic tests according to the invention, is indicated as a whole with the number 10. This structure is adapted to interact with machines that operate in a known manner.

This kit structure 10 comprises a support 11, such as a body made of plastic material (for example polypropylene), in one piece, produced by molding.

The support surface 11 is entirely opaque to light and is preferably black.

This support 11 extends prevalently in a main direction and has, at one end, an engagement tab 12 and, subsequent thereto, a plurality of housings for the various substances to be used for the test.

In particular, immediately subsequent to the engagement tab 12 is a first housing 13, with a closed bottom, adapted to contain the sample to be analyzed.

Subsequent to the first housing 13 is a group of four second housings in succession, indicated with 14A, 14B, 14C, 14D, equipped with a bottom and adapted to contain substances useful for the test, such as substrate, conjugate, stop solution and diluent of the samples.

These second housings 14 are advantageously closed at the top by a film 15 heat sealed to the support 11 and which is adapted to be pierced during the test for the collection of substances by the machine with which the support interacts.

Downstream of the second housings 14 are two third housings 16 in succession, adapted to contain respective wells 17 containing substances to be combined during the test, such as specific antigens/antibodies related to the test to be conducted.

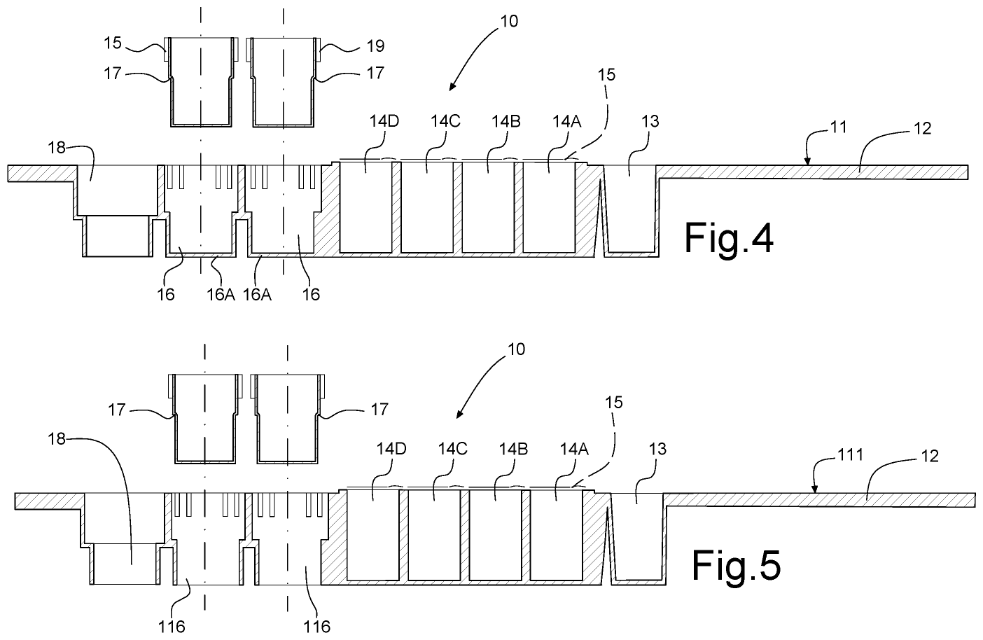

In this example (FIG. 4), the test is of luminescent, for example chemiluminescent, type and the third housings 16 have respective bottoms 16A, i.e., are open only at the top, at the mouth through which the wells 17 are inserted.

Downstream of the third housings 16 is a fourth housing 18, with no bottom, for containing a possible additional reagent.

The wells 17 are made of a plastic material transparent to light, such as polystyrene. They are cup shaped in order to be snap fitted into the third housings 16 and have a ring of teeth 19 to facilitate snap-fitting coupling with these housings.

In this example, the single-use test kit, as said, allows chemiluminescence determination to be carried out. By introducing luminol (for example collected from one of the second housings 14) in the wells 17 inserted in the third housings 16), this reacts with the antigens/antibodies present therein (following suitable treatment with other substances always present in the second housings), and a chemiluminescent reaction occurs, which is measured with a suitable photometer present in the machine with which the support interacts, positioned above the third housing. The well 17 is transparent, the third housing 16 into which it is inserted is completely opaque to light and therefore there is no light interference from outside and from the adjacent well, which would distort the test result.

FIGS. 2, 3 and 5 show the case of a single-use test kit for a determination of colorimetric type. The only difference compared to the example described above lies in the bottoms of the third housings 16.

In practice, in this example, the wells are the same as those described above, i.e., are made of a material transparent to light, and are therefore indicated with the same number 17. The support for the wells is also substantially the same, with the sole difference that the third housings (now indicated with 116) have no bottom 16A, and is indicated with the number 111.

The fact that the third housings 116 have no bottom allows the passage from below of beams of light adapted to strike the content of the wells 17 in these housings and reading, by means of the photometer above, of the absorbance of the colored solution in the wells.

In practice, the kit structure according to the invention allows the use of transparent wells also for those tests for which in the past opaque wells were used as it was necessary to isolate the wells from the external light.

This way possible using supports with surfaces, at least the surface relating to the housings adapted to receive the wells, that are opaque, so as to surround the wells by means of an opaque interface that isolates them from non-operational external light.

This solution makes it possible to have an inventory (and hence a stock) only of wells of transparent type, containing the substances required for the determinations. When the test to be conducted is of colorimetric type, the transparent well is inserted in the housing with no bottom of an opaque support, so that the test can be conducted without limitations. When the test to be conducted is of luminescent, for example chemiluminescent, type, the transparent well is inserted into the housing with a closed bottom of a support with opaque surface.

It is understood that above illustration represents only possible non-limiting embodiments of the invention, which can vary in forms and arrangements without departing from the scope of the concept on which the invention is based. The presence of any reference numbers in the appended claims is for the sole purpose of facilitating the reading thereof in the light of the foregoing description and of the accompanying drawings and in no way limits the scope of protection.

1. A system for single-use immunochemical tests, comprising:
a well, carrying a substance to be combined with the sample during the test; and
a support, equipped along a main direction, with a plurality of housings, comprising
at least one first housing for the sample to be analyzed,
at least one second housing for substances to be combined with the sample during the test,
at least one third housing for said well carrying a substance to be combined with the sample during the test,
wherein the surface of said at least one third housing of said support is opaque to light and said well is made of a material at least partially transparent to light, and in that said at least one third housing is
equipped with a through-hole on the bottom, so that a beam of light can pass through said bottom of the third housing and through said well, in order to conduct a colorimetric absorbance test
or
equipped with a closed bottom in order to conduct a luminescence test in the well,
so that said system uses a single type of well at least partly transparent to light to conduct colorimetric absorbance and luminescence tests.

2. The system for single-use immunoenzymatic tests according to claim 1, wherein the entire surface of said support is opaque to light.

3. The system for single-use immunoenzymatic tests according to claim 1, wherein all of said support is made completely from a material opaque to light.

4. The system for single-use immunoenzymatic tests according to claim 1, wherein at least the surface of said at least one third housing of said support is black.

5. The system for single-use immunoenzymatic tests according to claim 1, wherein the entire surface of said support is black.

6. The system for single-use immunoenzymatic tests according to claim 1, wherein said support extends prevalently in a main direction and has, at one end, an engagement tab and, subsequent thereto, in succession
one said first housing, with a closed bottom, adapted to contain the sample to be analyzed,
a group of at least three, preferably four, second housings in succession, equipped with a bottom and adapted to contain substances,
at least said two third housings, preferably two, adapted to contain respective said transparent wells,
said at least one fourth housing, preferably one.

7. The system for single-use immunochemical tests according to claim 6, wherein said at least one fourth housing has no bottom.

8. The system for single-use immunochemical tests according to claim 1, wherein said at least one second housing is closed at the top by a film fixed to said support.

9. A kit structure for immunoenzymatic tests comprising the components of the system according to claim 1.

10. A method for the preparation of a single-use immunochemical test for a sample to be analyzed, the method comprising:
providing a well made of a material at least partially transparent to light carrying a substance to be combined with the sample during the test, and
if the immunochemical test is of colorimetric absorbance type, providing
a support equipped, along a main direction, with a plurality of housings, including at least one first housing for the sample to be analyzed, at least one second housing for substances to be combined with the sample during the test, at least one third housing for said well carrying a substance to be combined with the sample during the test, wherein the surface of said at least one third housing of the support is opaque to light and moreover the at least one third housing is equipped with a through-hole on the bottom, so that a beam of light can pass through the bottom of the third housing and through the well, in order to conduct the colorimetric absorbance test,
if the immunochemical test is of luminescence type, providing
a support equipped, along a main direction, with a plurality of housings, including at least one first housing for the sample to be analyzed, at least one second housing for substances to be combined with the sample during the test, at least one third housing for said well carrying the substance to be combined with the sample during the test,
wherein the surface of said at least one third housing of the support is opaque to luce and said third housing is also equipped with a closed bottom in order to conduct a luminescence test in the well,
so that the method uses a single type of well at least partly transparent to light to conduct colorimetric absorbance and luminescence tests.
